(19) United States
(12) Patent Application Publication
(10) Pub. No.: US 2007/0134395 A1
(43) Pub. Date: Jun. 14, 2007

(54) Method of reducing manganese in defatted soy isolate

(76) Inventor: Everett L. Hodges, San Clemente, CA (US)

Correspondence Address: STETINA BRUNDA GARRED & BRUCKER, 75 ENTERPRISE, SUITE 250, ALISO VIEJO, CA, 92656, US

(21) Appl. No.: 11/636,865

(22) Filed: Dec. 11, 2006

Related U.S. Application Data
(60) Provisional application No. 60/749,961, filed on Dec. 13, 2005.

(51) Int. Cl. A23C 9/154

(52) U.S. Cl. 426/580

(57) ABSTRACT

The invention contemplates an infant formula for feeding to a neonate as a replacement for female human breast milk. The infant formula has a manganese concentration that is no greater than about ten times the manganese concentration in female human breast milk. The infant formula may additionally include supplements for decreasing the effect of manganese on the infant. The infant formula may be predominantly soy-based. The invention also contemplates a method of reducing manganese in infant formula. The method includes contacting a slurry of soy-based infant formula with a chelating agent. The chelating agent may be alumina, which may be regenerated for further use.

### CROSS-REFERENCE TO RELATED APPLICATIONS

This application claims the benefit of U.S. Provisional Application No. 60/749,961, filed on Dec. 13, 2005, the teachings of which are expressly incorporated by reference.

### STATEMENT RE: FEDERALLY SPONSORED RESEARCH/DEVELOPMENT

Not Applicable

### BACKGROUND

The present invention relates generally to a process for removing excessive Manganese (Mn) from defatted soybean isolate and other high-Mn-content products and to an improved infant formula having reduced Mn content. Advantageously, the process is specifically adapted to reduce, but not entirely eliminate, excessive Mn levels while maintaining other essential metals, minerals and vitamins in soy isolate. In this regard, the process decreases the naturally occurring high level of Mn in soy isolate which is used in certain products.

Scientific research indicates that soy isolate contains approximately 60 times the level of Mn that is found in human breast milk. Several peer-reviewed scientific studies have reported that animals that were fed products containing levels of Mn equal to that found in soy isolate had significantly lower levels of the dopamine neurotransmitter. It is well known that the neurotransmitter dopamine is critical for maintaining the mental and physical well-being of all animal species including humans. In particular, it is known that dopamine is responsible for regulating brain processes that control movement, emotional response, and in providing feelings of pleasure, motivation as well as pain. Dopamine disorders in the brain can result in neurological impairment including deficits in attention and cognitive ability.

In this regard, one study reports that newborn primates that were fed commercially-available soy-based infant formula were neurologically compromised. Other studies have suggested that mammals exposed to high ambient levels of Mn experienced a loss of executive function (EF). In humans, EF is more commonly referred to as Attention Deficit Hyperactivity Disorder (ADHD) which is associated with dopamine dysregulation. The extent of ADHD has been documented in a recently published report which indicates that 8% of the US population suffers from ADHD. Furthermore, multiple reports indicate that rates of the ADHD population within the U.S. criminal justice system is in excess of 50%.

In addition, in 1991, the National Center for Health Statistics reported that the homicide rate for males between the ages of 15-24 in the United States was approximately 37 homicides per 100,000 population. In contrast, the homicide rate in Italy was only 4.3 homicides per 100,000 population. Violence in the United States is not limited to certain social groups or certain geographical areas despite widespread beliefs that violent behavior is only associated with specific races, educational levels or inner-city areas.

Notably, an investigation by the Environmental Protection Agency (EPA) entitled Toxic Release Index indicates that areas with high ambient levels of Mn have a statistically significant higher arrest rates for violence and driving under the influence of alcohol (DUI). Furthermore, there is a large body of science suggesting that geographic areas wherein exposure to significant levels of Mn occurs via contact with water, food and air with high Mn-levels (such as in industrial areas where Mn is present) there is a correspondingly high ratio of ADHD as well as aberrant and/or violent behavior, regardless of age, income, racial or ethnic background.

In a 1994 report, the California Attorney General convened a counsel to study violence and design strategies that may be effective in reversing a trend towards violence in our society. The 1994 report indicated that violence was attributed to many factors but that violence was primarily a “learned” behavior. Furthermore, the 1994 report listed the following causal and contributing factors of violent episodes: alcohol and other drugs, decline in educational level, devaluing of life, race discrimination, media influence, mental health problems, economic poverty, hopelessness, lack of responsibility, isolation and alienation, and easy access to firearms.

In addition, the 1994 report indicated that the understanding of certain causes could have a great effect on the reduction of violence. Specifically, the 1994 report indicated that control of the media, firearms, alcohol and placement of greater emphasis on community, family relationships, youth, respect for diversity, and personal and social responsibility as critical factors in reducing violence. In summary, the 1994 report focused on activities wherein violent behavior could be “unlearned” in order to minimize violent episodes in our society. The 1994 report ignored other causes of violent episodes in our society and, in particular, failed to note causes that may be biochemically based.

In the 1994 report and in many other studies on violence, causes of violence other than “learned” violent behavior have largely been minimized or otherwise ignored. However, there is a growing body of science that reports that many violent episodes are biochemically related. Accordingly, it is believed that biochemical causes of violent episodes are a substantial factor and should be addressed and identified and understood in order to minimize and eliminate the effect of biochemical causes as related to violent episodes.

Recent scientific research indicates that infant formula may be linked to behavioral problems which are manifested in violent episodes in certain individuals. Furthermore, there is a large amount of scientific evidence and much literature available which indicates that soy-based infant formula is harmful to the development of newborns and neonates. More specifically, it is recognized that soy-based infant formula contains high levels of Mn that naturally occur in soybean filler. Animal studies have confirmed that the high levels of Mn found in commercially-available soy based infant formula are responsible for destroying dopamine and serotonin neurotransmitters. Serotonin is the neurotransmitter that is associated with the control of aggression.

Additional research suggests that excess Mn in the body tends to replace deficiencies of calcium and iron. Other reports indicate that excess amounts of Mn increase the destruction of dopamine and serotonin neurotransmitters. A December, 2004 article published in Archives of Pediatrics and Adolescent Medicine reported on a French study of 110 children from the same school district who were evaluated for ADHD. The French study indicated that the children who were diagnosed with ADHD children were also iron-deficient. The study also indicated that the lower the iron level in the ADHD children, the more problematic the child's behavior and hyperactivity and the lower the child's cognitive scores.

One report released in 1990 by Vincent A. Murphy et al. documented the results of a study showing that rat pups that were calcium-deficient had been fed products containing magnesium acetate. The report indicated that the calcium-deficient rat pups also had a 900% greater amount of Mn in the cerebral column tissue and fluids. Unfortunately, the use of high-Mn-content diets is prevalent in certain food products intended for human consumption. For example, many soy-based infant formulas are reported to have high levels of Mn.

More particularly, many soy-based infant formulas contain from 50-80 times the concentration of Mn as compared to Mn concentration levels in female human breast milk. Unfortunately, the metabolic system (i.e., liver) of a newborn human infant is not developed to the extent necessary to dispose of the high levels of Mn from soy-based infant formula until four to six months of age. Unable to dispose of the excess Mn, it collects in the critical basal ganglia region of the brain of the infant and affects the production of dopamine-bearing neurons responsible for neurological development.

Throughout history, the detrimental effects of Mn in humans are well noted. For example, there are hundreds of scientific articles reporting that excessive exposure to Mn can be devastating. The ancient Greeks noted that individuals who worked in Mn mines often manifested a Parkinson's Disease-type of dementia associated with aberrant and violent behavior. Many modern scientists have classified Mn as an unrecognized stealth neurotoxin. Although trace amounts of Mn are known to be vital to the proper development of the infant brain, it is believed that toxic levels of Mn occurs in infants who ingest soy-based infant formula. Some infants who have ingested extremely small amounts of Mn will manifest disproportionate neurological problems.

In one recent study by Dr. Jon Ericson et al. of the University of California in Irvine, it was reported that pregnant women residing in high ambient Mn areas have given birth to children diagnosed with impulse control problems. Of significant concern is the fact that these children manifested this neurological problem at 2½, 6 and 8 years of age which leads to a conclusion that neurological damage seems to be permanent. Dr. Ericson reported to the California Assembly Public Safety Committee that he collected teeth from 8-10 year-old children from multiple areas in the US.

The children's teeth were analyzed in order to determine the children's exposure to Mn levels over time, especially during the pre-natal and newborn period. Dr. Ericson's team determined that during the 20^{th} week of gestation, there was a significant uptake of Mn in the tooth. Importantly, the 20^{th} week of gestation is the point in time during which the singulet develops in the brain. The singulet is the portion of the brain responsible for the modulation of Mn. The results of the study indicate a critical period during human development when exposure to Mn occurs and which may later be manifested in neurological problems such as ADHD.

Children who are born and raised in underprivileged society represent the greatest proportion of individuals believed to receive a disproportionate amount of infant formula. For example, thousands of underprivileged mothers are eligible to receive free infant formula from a government-funded Women, Infants and Children (WIC) nutrition program. Unfortunately, much of the infant formula that was distributed in the WIC program is soy-based infant formula. As was earlier indicated, it is believed that such soy-based infant formula has toxic levels of Mn contained therewithin.

For example, the mean amount of Mn delivered to an infant suckling on a female human breast is believed to be about 4-6 micrograms per liter (mcg/L) or about 0.004-0.006 milligrams per liter (mg/L). However, the Food and Drug Administration (FDA) currently permits 0.6 milligrams (mg) of Mn per day for infants up to 6 months of age. This amount is 120 times the amount found in female human breast milk. Scientific literature indicates that several popular soy-based infant formulae that was tested for Mn contained anywhere from 0.2 mg to 1 mg per quart of ingested formula. Higher Mn concentrations were found in other soy-based infant formula wherein Mn concentrations ranged from 0.4 mg to 2.2 mg administered.

Research shows that a neonate is capable of absorbing approximately 1.1 mg of Mn above metabolic need from soy-based infant formula. As was earlier mentioned, because a neonate's liver is not fully developed, the liver is incapable of processing the increased Mn concentration by excreting the excess Mn. Instead, neonates ingest the Mn which is absorbed in blood plasma and red blood cells and which then permeates into the liver, kidneys and other soft tissues of the body including the brain.

It is well known that the brain of a neonate undergoes tremendous change including the proliferation of neurons, dendrites, and synapses during the first months of the neonate's life. Because of the tremendous growth occurring in the brain, Mn which is ingested during this period is deposited in the critical basal ganglia region. More specifically, excess Mn that the neonate is unable to metabolize is stored in body organs including about eight percent of the Mn which is stored in the basal ganglia region. As was earlier mentioned, this area of the brain is in close proximity to dopamine-bearing neurons which are responsible, in part, for adolescent neurological development. It is believed that toxic levels of Mn have an effect on behavior during puberty when extreme stresses experienced during pubescence are unleashed upon the dopamine neurons with the unfortunate consequence of outbursts of violent behavior in certain adolescents.

Scientific studies indicate that prison inmates as well as children suffering from ADHD have increased levels of Mn as measured by head hair which is known to store Mn therewithin. Mn content is therefore easily checked by sampling hair follicles. Scientific studies also show that certain societies having high exposure to Mn in their environment exhibit an increased propensity towards crime. Furthermore, studies show that neonates fed with soy-based infant formula containing increased Mn concentration levels have an intelligence quotient (IQ) on average of about eight points lower than the IQ of neonates who are fed with female human breast milk. As was stated earlier, it is believed that absorption of excessive Mn within neonates destroys dopamine neurotransmitters and serotonin neurotransmitters which are both associated with altered and sometimes violent behavior patterns.

It is known that the detrimental effects of Mn exposure, (e.g. environmental exposure or dietary exposure) to the neonate is more harmful as compared to exposure to excess Mn in adults. This is because adults possess a mechanism by which excess Mn in their diet can be handled wherein the excess Mn is contained and absorbed in the adult body and later extracted though bile. Unfortunately, neonates do not have this mechanism developed to a sufficient extent and therefore such neonates are prone to absorb all available Mn that is consumed in their daily diet. In addition, bile flow is relatively low for neonates.

Moreover, neonates are prone to absorb excess Mn because of a general “leakiness” of the intestines as well as the presence of tissue sites having a high affinity for Mn. In support thereof, in animal models, neonatal intestinal absorption of Mn is about seventy percent to about eighty percent as compared to the intestinal absorption of Mn in adults which is about one percent to about two percent. Therefore, although excess Mn concentration in adults may not be detrimental, such excess Mn concentration as may be found in infant formula is detrimental to neonates.

Testing was preformed to substantiate the corollary between excess Mn absorption in neonates and violent behavior. In one experiment, male rhesus monkeys were tested by providing three groups of eight monkeys. The three groups of rhesus monkeys were fed infant formula that contained varying levels (i.e. concentrations) of Mn from the time of birth until eighteen months of age. Male rhesus monkeys were selected because of their striking similarity to human anatomy with respect to maturity of brain development at birth, prolonged period of time for postnatal brain development, as well as their complexity of behavioral repertoire.

The first group (i.e., control group) of eight monkeys were initially fed experimental formula which consisted of cow's milk based infant formula having a Mn-content of 0.03 micrograms/milliliter (mcg/mL). A second group (i.e., low group) of eight monkeys were fed experimental formula which consisted of soy-based infant formula having 0.3 mcg/mL. Lastly, a third group (i.e., high group) of eight monkeys were fed experimental formula which consisted of soy-based infant formula having increased manganese levels in the amount of 1 mcg/mL. The experimental formulae were fed to the respective groups of monkeys during the first four months of the monkeys' lives.

During the four month period, each monkey was observed with respect to gross motor maturation (i.e., walking, climbing, manual activity and behavioral changes), level of major metabolite of dopamine, level of serotonin metabolite, indication of serotonin turnover and discrimination reversal tasks. The results of such observations are shown in FIGS. 1-7. FIG. 1 illustrates the observations of the monkeys with respect to walking. As can be seen in FIG. 1, the control group and the low group followed a developmentally appropriate pattern wherein the monkeys exhibited an early increase in walking activity which eventually tapered off. In contrast, the high group was more active earlier than the control group and the low group and continued to be more active.

FIG. 2 illustrates observations of the monkeys with respect to climbing activity. As can be seen, the control group and the high group exhibited normal patterns of gross motor maturation. In particular, both groups started climbing at about the fifth week and leveled off at about the eighth or ninth week. The low group also started to climb at about the fifth week but was more active in climbing as compared to the level of activity in the control or high groups which may be described as “agitated” or over exuberant climbing. One possible explanation for this exuberant level of activity in climbing is that the high group exhibits normal growth motor maturation with respect to climbing but the high groups still exhibit agitated behavior with respect to walking (see FIG. 1) which is a more primitive form of behavior as compared to climbing.

FIG. 3 illustrates observations of the monkeys with respect to manual activity. As can be seen, the control group and the low group each exhibited a gradual decrease in manual activity over the twelve month period which is a normal growth motor maturation timeframe. However, the high group was overly active and less purposeful in their manual activity. FIG. 4 illustrates the results of observations of monkeys with respect to behavior changes. In this regard, the low and high groups each exhibited more behavior changes which is indicative of over activity as compared to the control group.

FIG. 5 illustrates levels of dopamine and its major metabolite (i.e., homovanillic acid or HVA). In particular, it can be seen that there is no difference between levels of dopamine for the three groups. However, the low and high groups each exhibited a fifteen percent decrement (i.e., consecutively counting down) in dopamine turnover. FIG. 6 illustrates levels of serotonin and its major metabolite (i.e. five hydroxyindoleacetic acid or 5HIAA). In particular, it is noted that no difference exists between levels of serotonin for the three groups. However, there is an inverse relationship that exists between the concentration of manganese and the level of 5HIAA. More particularly, the low group exhibited about seventy-five percent of the 5HIAA as compared to the control group. Furthermore, the high group exhibited about sixty percent of the 5HIAA as compared to the control group.

FIG. 7 illustrates each monkey's ability to inhibit impulsive tendencies to persist even though persistence may be futile. In other words, an impulsive tendency to persist despite futility is correlated to loss of mental flexibility in the particular monkey's brain. As shown in FIG. 7, the low group of monkeys as well as the high group made many more balks on a reversal test as compared to the control group. Such behavior is typical of human children who have ADHD.

Based on the above described experiments and observations as indicated in FIGS. 1-7, the results after four months show that the high and low groups of monkeys exhibited aberrant patterns of motor development and that there is an indicated manganese dose-related decrement in major dopamine and serotonin metabolites. As can be seen, the primate studies (i.e., rhesus monkeys studies) support applicant's belief of a link between toxic levels of manganese in neonates and violent behavior in adolescents. As such, it is believed that soy-based infant formula is a biochemical cause of violence of the neonate's adulthood.

As such, there exists a need in the art for an infant formula that may be used as a replacement for female human breast milk and which has a reduced manganese concentration. Furthermore, there exists a need in the art for an infant formula having a manganese concentration that is less than that which is contained within commercially available soy-based infant formula. Also, there exists a need in the art for a method for preparing infant formula having reduced manganese concentration level. Finally, there exists a need in the art for a method for minimizing or eliminating excess manganese concentration levels in infant formula such as soy-based infant formula.

### BRIEF SUMMARY

The present invention specifically addresses the above-mentioned need associated with infant formula and provides an infant formula that has a reduced manganese concentration level and therefore may be safely used for feeding to a neonate as a replacement for female human breast milk. Preferably, the infant formula of the present invention has a manganese concentration that is preferably no greater than about ten times the manganese concentration in female human breast milk. The infant formula is preferably soy-based and may be substantially comprised of soy protein isolate. Also disclosed is a method of reducing manganese concentration in infant formula by using a chelating agent such as alumina particles or by using an ion exchange resin to reduce manganese concentration levels in soy-based infant formula.

Although the infant formula preferably has a manganese concentration level that is no greater than about ten times the manganese concentration of female human breast milk, it is contemplated that the infant formula may be formulated and processed to any alternative amounts of manganese concentration. Furthermore, the infant formula may be specifically formulated to the nutritive quality of female human breast milk by including various minerals and vitamins including calcium, iron, proteins, carbohydrates and fat. The infant formula may be fortified with calcium, iron, vitamin D and/or omega 3 fatty acids in the appropriate concentrations to control the amount of manganese that is absorbed by the neonate. Such vitamins, minerals and acids are believed to affect the amount of manganese that is absorbed by neurotransmitters which are associated with violent behavior in adolescence, as was indicated above.

As was earlier mentioned, the infant formula may be soy-based and may be comprised substantially of soy protein isolate (SPI) which is one of the most highly refined soy products available and which is consequently used as a dairy substance such as infant formula. In this regard, a method is disclosed for reducing manganese in infant formula and specifically with regard to the reduction of manganese concentration in soy-based infant formula such as infant formula that is based on SPI. The SPI may be initially prepared starting with a defatted soybean meal wherein the infant formula is prepared using an initial step of removing fat from the protein prior to removal of the manganese. The fats may be reinserted into the soy-based infant formula prior to usage.

The method may further comprise the steps of providing a slurry of soy-based infant formula which has a manganese concentration and placing the slurry into contact with a chelating agent which causes certain metal irons to bind together in order to reduce their bioavailability. The manganese may be reduced in concentration level by exposure to the chelating agent wherein the chelating agent functions as a separating medium. Alumina may be used as the separating medium for reducing manganese. Exposure of finely divided alumina to the soy protein results in the removal of significant amounts of manganese. The alumina particles may be reconditioned after exposure to the slurry by exposure to sulfate solution so that the spent alumina may be regenerated and reused in the process for producing low-manganese or manganese-free infant formula.

Removal of manganese concentration levels in the infant formula may be effectuated through the use of ion exchange resins which are typically available as synthetic polymer beads. Negatively charged species of ion exchange resins contain mobile ions that are cations such that the resin is termed a cation exchange resin. Positively charged species of ion exchange resins contain mobile ions that are anions such that the resin is termed an anion exchanger. For removal of manganese concentration from soy-based infant formula, it is contemplated that the positively charged species of the ion exchange resin may be used.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is graph illustrating results of a study on the neurobehavioral effects of excess manganese in soy formula fed to rhesus monkeys that were divided into several groups wherein a “High Group” of the monkeys exhibited walking at an earlier stage compared to a “Low Group” and a “Control Group” and further illustrating that the “High Group” exhibited an increased level of walking;

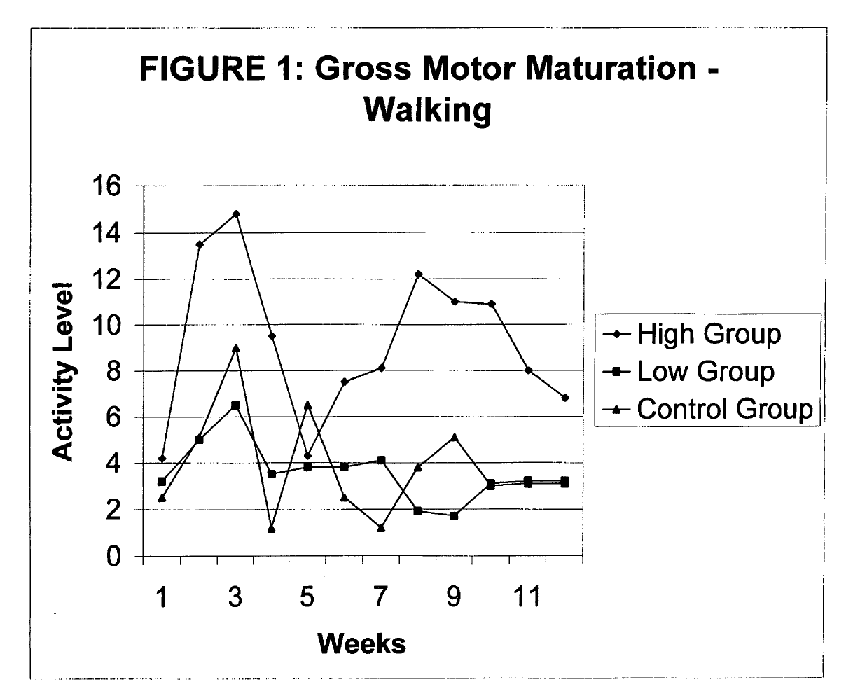

FIG. 2 is a graph illustrating that the “Low Group” of rhesus monkeys climbs at an earlier stage which is not developmentally appropriate;

FIG. 3 is a graph illustrating that the “High Group” becomes excessively active and less purposeful in their manual activity;

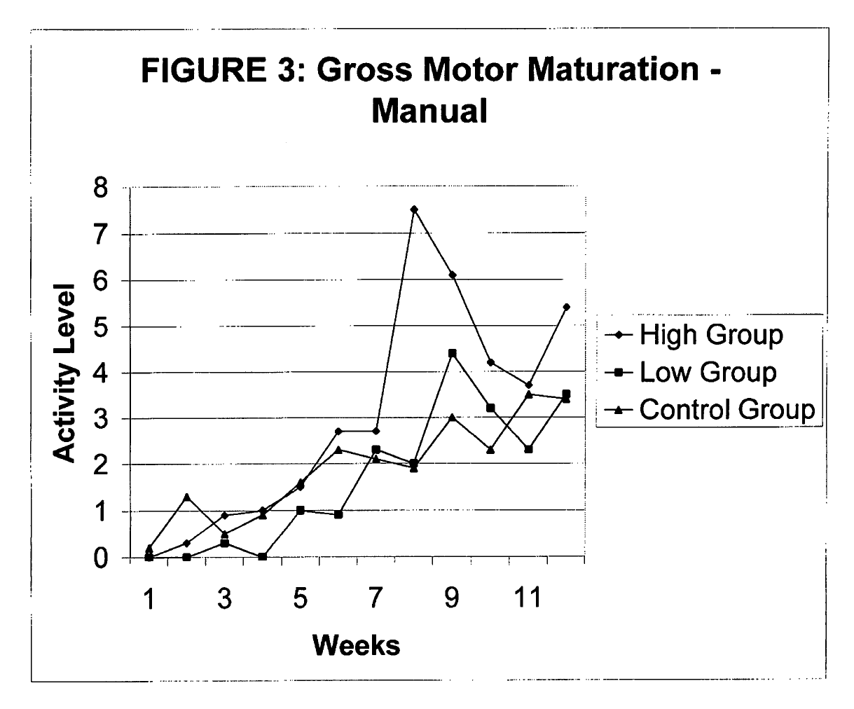

FIG. 4 is a graph illustrating that the “High Group” engaged in more behavior changes which may be a sign of overactivity;

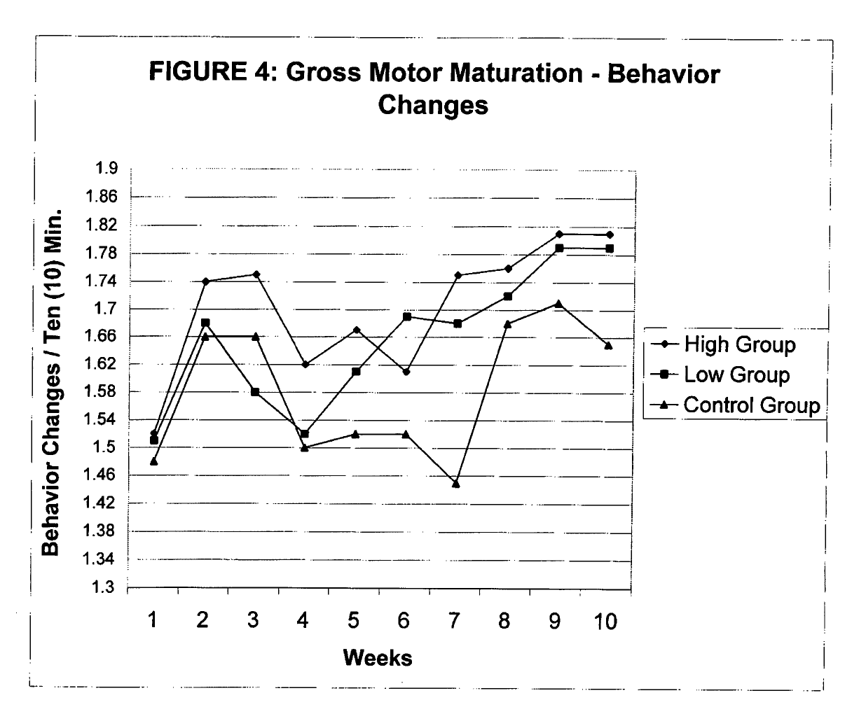

FIG. 5 is a bar chart illustrating that the “Low Group” and the “High Group” have a 15% decrement in dopamine turnover;

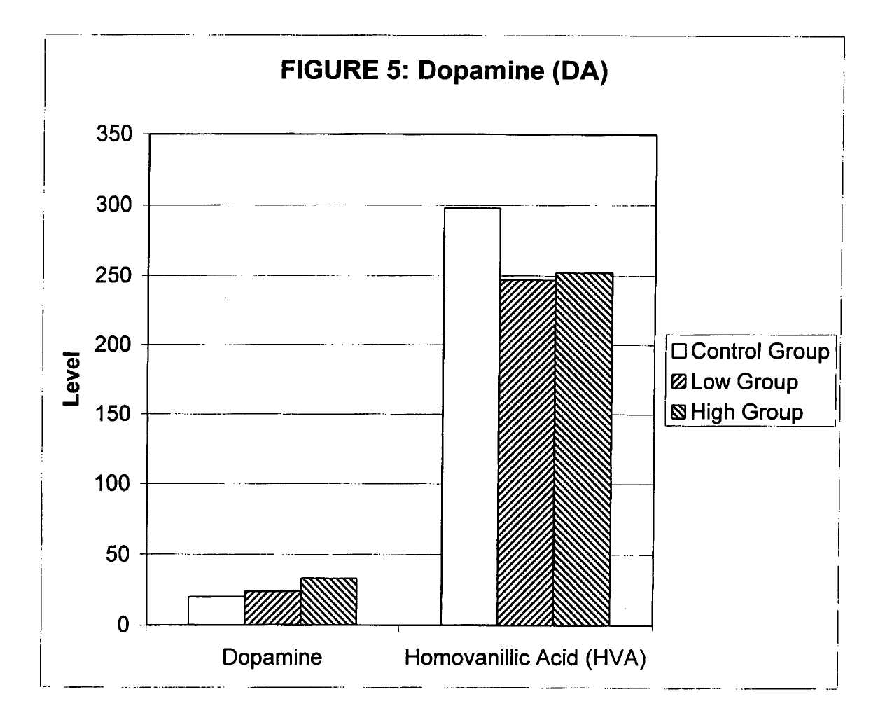

FIG. 6 is a bar chart illustrating an inverse relationship between manganese exposure and the level of the serotonin metabolite;

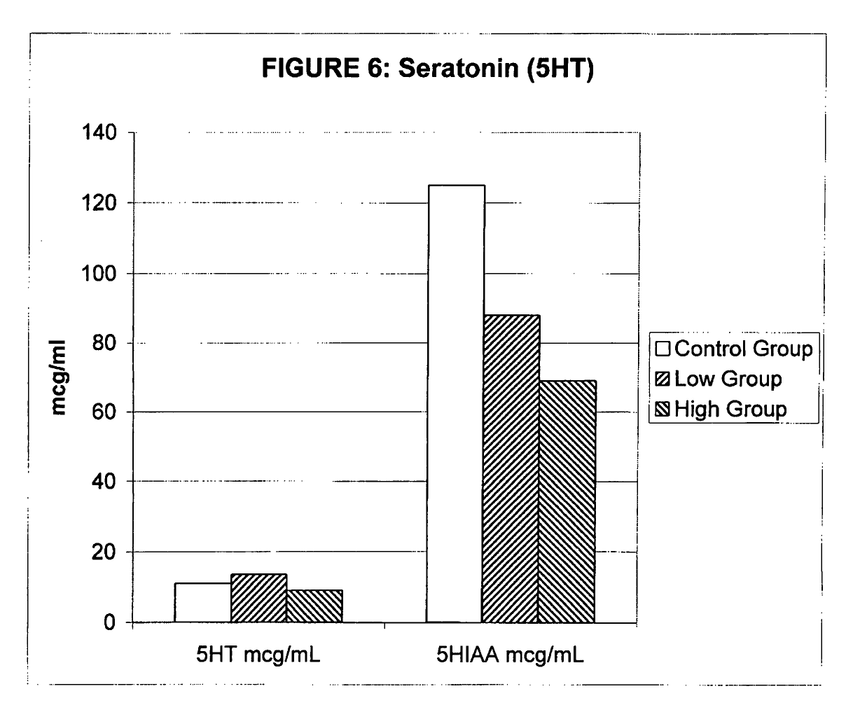

FIG. 7 is a bar chart illustrating that the “High Group” made more balks on the reversal test as compared to the “Control Group”; and

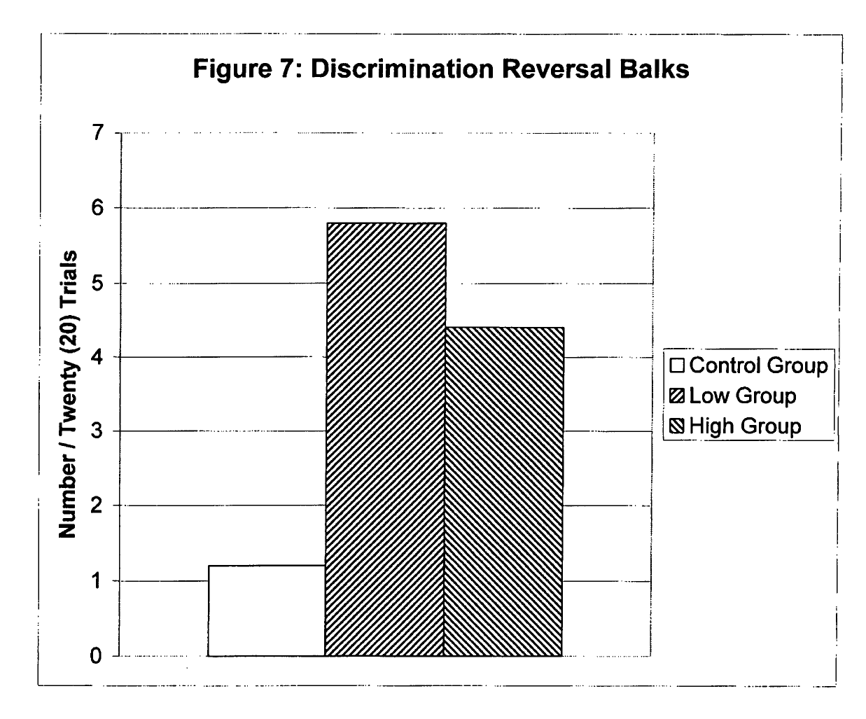

FIG. 8 is a schematic diagram of a system and method for removal of Manganese from a solution such as soy-based infant formula wherein a soy slurry may be passed through a column in a top-to-bottom direction in a pressurized manner through a separating medium contained within the column.

### DETAILED DESCRIPTION

The present invention comprises infant formula such as may be used for feeding to a neonate as a replacement for female human breast milk. Advantageously, the infant formula of the present invention has a reduced manganese concentration level and, more particularly, has a manganese concentration that is preferably no greater than about ten times the manganese concentration in female human breast milk. Also provided in the present invention is the infant formula that is soy-based.

The infant formula preferably has a manganese concentration that is no greater than about ten times that of female human breast milk. Also disclosed is a method of reducing manganese concentration in infant formula by using a chelating agent. Although it is contemplated that the infant formula of the present invention is soy-based, other aspects of the present invention described herein that may be practiced with infant formula may be based on cow's milk, goat's milk, and rice as well as other protein-based and/or dietary fiber drinks.

In an aspect of the present invention, the infant formula disclosed herein may have a manganese concentration level that is lower on average than manganese concentration levels in prior art infant formula. The average manganese concentration level of infant formula is believed to be related to its base. For example, the manganese concentration level of soy-based infant formula is believed to be different than the manganese concentration of infant formula that is based on cow's milk or rice. Furthermore, infant formula that is soy-based is believed to contain about 200 to 300 micrograms (mcg) per liter (L).

On the other hand, infant formula that is milk-based is believed to contain about 30 to 50 mcg/L. However, the female human breast milk is believed to contain about four to six mcg/L. Other studies indicate that certain soy-based infant formulas can result in as much as 200 times the level of manganese found in female human breast milk. As was earlier indicated, many experts believe that such high concentrations of manganese pose a threat to immature metabolic systems of infants up to six months of age. Furthermore, research indicates that one of every eight infants that is fed soy-based infant formula during the first six months of life is at risk for brain development problems and behavioral disorders which are unfortunately not evident until adolescence.

Therefore, the present invention comprises an infant formula having a manganese concentration level that is no greater than about ten times the manganese concentration of female human breast milk. However, it is contemplated that the infant formula of the present invention may be formulated and processed to any alternative amounts of manganese concentration, as will be discussed in greater detail below.

In addition, the infant formula of the present invention may be specifically formulated to simulate female human breast milk with respect to its nutritional content (i.e., type) and concentration level (i.e., amount). Simulation of the nutritive quality of female human breast milk is desirable as it is comprised of a complex blend of nutrients with respect to type and amount of nutrients and is believed to be an optimal complex blend of such nutrients that is necessary for the health and wellbeing and development of the neonate. For example, female human breast milk includes various minerals and vitamins including calcium, iron, proteins, carbohydrates, fat and in the appropriate concentrations.

Furthermore, female human breast milk does not contain overly excessive amount of protein such as might otherwise overload an infant's kidneys. Also, female human breast milk contains a sufficient amount of iron to help prevent the infant from becoming irritable, listless or anemic. Simply put, female human breast milk is believed to provide the optimal amount of nutrients at the appropriate concentration levels in addition to containing other components that are necessary for the proper development of an infant. It is believed that a neonate's diet is highly determinate of the neonate's intelligence, health and emotional and physical well being during adult years.

Commercially prepared infant formula attempts to imitate female human breast milk. Unfortunately, such commercially prepared infant formula is limited to the extent that it can achieve the correct blend and concentrations of certain nutrients. One reason for this is that such infant formula must be processed to have a sufficiently lengthy shelf life. Moreover, certain types of nutrients which are added or depleted from the infant formula are dependent upon identified nutrients which are necessary for healthy baby growth or which may be detrimental if provided in excessive quantities.

As was earlier indicated, one aspect of the present invention contemplates an infant formula for feeding to a neonate as a replacement for female human breast milk and preferably has a manganese concentration that is no greater than about ten times the manganese concentration in female human breast milk. In a further aspect of the present invention, the infant formula may be fortified with calcium, iron, vitamin D and/or omega 3 fatty acids. These minerals, vitamins and acids affect the neonate's ability to absorb manganese.

Furthermore, such vitamins, minerals and acids are also believed to affect the amount of manganese that is absorbed by neurotransmitters which are associated with violent behavior in adolescence. Calcium may be added to infant formula in an amount equal to the daily-recommended amount for neonates because it is believed that a lack of calcium results in an increase in the amount of manganese that is absorbed into the neonate's body. Conversely, providing the daily-recommended amounts of calcium and iron to the neonate helps to ensure that the neonate's ability to absorb manganese is maintained at a normal/acceptable level or at a level that is comparable to that when the neonate is feeding on female human breast milk.

In a further aspect of the present invention, vitamin D may be added to the infant formula. Vitamin D is believed to increase the neonate's ability to absorb calcium which, in turn, is believed to maintain the neonate's ability to absorb manganese at the lower level. Furthermore, the infant formula may be fortified with omega 3 fatty acids to decrease free radical distribution of excess manganese on neurotransmitters.

As was earlier indicated, the infant formula may be soy-based and may have a reduced manganese concentration. It is further contemplated that the soy-based infant formula is comprised substantially of soy protein isolate (SPI). Of the different types of soy products that are available to consumers, SPI's are believed to be the most highly refined products available. As is well known in the art, SPI's are used substantially as a dairy substance such as milk replacers.

Therefore, manufacturers commonly use SPI's in infant formula, nutritional supplements and other products such as meat and dairy products. SPI's are believed to contain about ninety percent protein as compared to soy protein concentrate which is believed to contain at least sixty-five percent protein. The infant formula of the present invention may be soy-based in that it may be produced from any form of soybean protein material. It is well known that soybean protein has impaired nutritional quality due to the presence of phytates which interfere with mineral absorption. Prior art methods exist for removal of such phytates.

In this regard, the disclosure presented herein describes a method for reducing manganese in infant formula and specifically with regard to the reduction of manganese concentration in soy-based infant formula such as infant formula that is based on SPI. The SPI may be initially prepared starting with a defatted soybean meal which may be mixed with an alkali solution to remove fiber. The defatted soybean meal may be washed in an acid solution to precipitate the protein. The protein may be then dipped into another alkali solution and dried at high temperatures. The SPI may then be formed into various shapes such as in the shape of protein fibers.

The method of the present invention includes an initial step of removing fat from the protein prior to removal of the manganese which will be discussed in greater detail below. However, it is contemplated that the fats may be reinserted into the soy-based infant formula prior to usage. The SPI's are produced by drawing the protein out of the defatted soybean product or soybean meal to result in the SPI having the ninety percent protein content on a moisture-free basis. The method of the present invention comprises the steps of providing a slurry of soy-based infant formula which has a manganese concentration. The method further comprises a step of placing the slurry into contact with a chelating agent. As is known in the art, chelating agents have the ability to bind certain metal irons together. Such metals are bound to make them less available (i.e., less bioavailability) for nutritive purposes.

It is contemplated that the manganese may be reduced in concentration level by exposure to the chelating agent wherein the chelating agent functions as a separating medium. In one example of the use of a chelating agent, U.S. Pat. No. 5,248,765 entitled Separation of Phytate from Plant Protein and Dietary Fiber Using Alumina, issued to Mazer et al., the entire contents of which is incorporated by reference herein, discloses the use of alumina as the separating medium for reducing manganese.

In the above-referenced patent, significant amounts of manganese from soy protein and/or similar ingredients are removed to provide a basis for the manufacture of low-manganese or manganese-free infant formula. The patent discloses the use of finely divided alumina as a separating medium. In this regard, a method is utilized wherein the infant formula soy is exposed to the alumina. It is contemplated that a preferred ratio of alumina exposed to the soy protein during the method is 1.5:1. In particular, one and a half pounds of alumina is thought to be able to remove a significant amount of manganese from a pound of soy protein. The alumina particles may be reconditioned after exposure to the slurry by exposing the alumina particles to sulfate solution. The spent alumina may be readily regenerated and reused in the process for producing low-manganese or manganese-free infant formula.

It is contemplated in the method of the present invention that the slurry may be placed into contact with the chelating agent (i.e., alumina particles) for a predetermined amount of time corresponding to the amount of desired decrease in manganese concentration in the soy-based infant formula. Such time control may be necessary due to differences in batches of defatted soybean product. As was earlier mentioned, the defatted soy product is initially used to produce the SPI.

In furtherance of this step, it is contemplated that the manganese concentration levels may be measured at periodic points during the processing of the infant formula. More specifically, the manganese concentration may be measured and the step of placing the slurry into contact with the alumina particles may be repeated until achieving the desired level of manganese concentration in the soy-based infant formula. It is contemplated that the soy slurry may be passed through a column 10 in a direction from the bottom 12 of the column to the top 14 of the column 10 in reverse of the top-to-bottom flow. Top-to-bottom flow is believed to result in heavy clogging of the separating medium 16 (i.e., alumina particles) present in the column 10. In addition, the bottom-to-top flow direction may also prevent compaction of the separating medium 16 by the soy slurry due to the relatively sticky consistency of the soy slurry.

Therefore, the method of the present invention contemplates a flow from the bottom 12 of the column 10 to the top 14 of the column 10 in a pressurized manner. More specifically, the flow may be characterized as a pressurized reverse flow of the soy slurry through the media bed 16 opposite the direction of gravity. The pressurized flow may be facilitated through the use of a pump 18 such as a peristaltic pump disposed at a bottom end of the column. It is believed that reverse flow from bottom to top as disclosed herein eliminates or minimizes poor separating caused by heavy clogging of the separating medium 16 as well as preventing compaction of the separating medium 16.

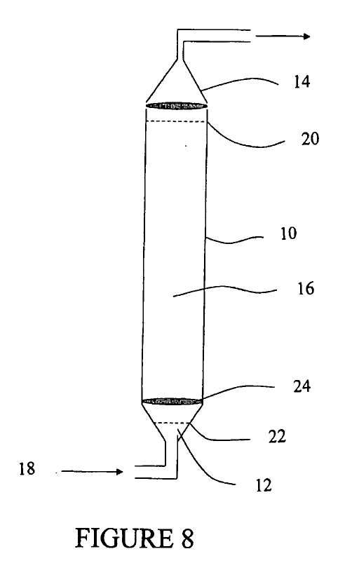

As shown in FIG. 8, the soy slurry may be passed through a column 10 having a top end 14 and a bottom end 12 with a top filter trap 20 and a bottom filter trap 22 disposed respectively thereat. The top filter trap 20 is preferably configured to prevent the escape of the separating medium 16 when the treated soy slurry flows out of the top end 14. The bottom filter trap 22 is preferably configured to prevent loss of the separating medium 16 during back-flushing of the separating medium 16 and to prevent entrainment of the separating medium 16 in the treated soy slurry. A support plate 24 may further be installed in the column 10 adjacent to and above the bottom filter trap 22 and is preferably configured to support the separating medium 16 contained within the column 10.

Regarding the column 10 itself, it is contemplated that the column 10 is configured as a clear plastic tube that is preferably about 100 to 125 cm in length and which has a width or diameter in the range of from about 2-5 cm. However, the column may be provided in any length, width, diameter and shape that is suitable to perform the separating process. In this regard, the column 10 is preferably configured to allow access to the separating medium 16 wherein the separating medium 16 may be pre-treated, retreated or replaced periodically.

The column 10 and pump 18 are preferably configured for repeated use with fluids such as soy slurries having a pH in the range of from about 3-11 although the duration over which the column 10 and pump 18 are subjected to such pH levels is preferably short. For example, during cleaning and/or pre-treating of the separating medium 16, solutions of sulphuric acid and/or sodium hydroxide may be used such that the column 10 and pump 18 are preferably capable of withstanding repeated contact with such solutions.

The column 10 is preferably filled to about 60 to 70 percent of its height with the separating medium 16 although any proportion of the column 10 may be filled with the separating medium 16. As was earlier mentioned, the top and bottom filter traps 20, 22 are preferably provided at opposite ends of the column 10 in order to contain a majority of the separating medium 16 within the column 10. Waste outlets may be included at the top and bottom ends 14, 12 of the column 10 in order to facilitate upward and downward flushing of the column 10 during cleaning and/or flushing procedures.

As was earlier mentioned, the separating medium 16 may be provided as alumina which preferably has a narrow particle size distribution. Furthermore, the pore size of the top and bottom filter traps 20, 22 is preferably matched to the particle size of the alumina in order to minimize flow of the separating medium 16 (i.e., the alumina) either forward into the soy slurry or backward into the material (i.e., untreated soy slurry) flowing into the column 10 at the bottom end 12. Although entrainment of alumina into the soy slurry and eventual consumption thereof by humans is no longer believed to be causally related to Alzheimer's disease, other complications may develop as a result of human ingestion of the alumina particles.

Because alumina does not dissolve in acidic solutions and only reluctantly dissolves in basic solutions, concerns for dissolution of alumina in the treated soy slurry produced via the method disclosed herein is no longer believed to be valid. Regardless, composition testing of the treated soy slurry for alumina and other ferrous particles is preferably performed via any number of suitable testing procedures such as using inductively-coupled plasma testing (ICP), X-Ray Fluorescence testing (XRF), or any other suitable procedure.

Bench scale testing may be performed to determine the alumina content, if any, in the treated soy slurry prior to production scale filtration thereof. Pre-treatment of the soy slurry may also be initially performed to determine the effects thereof on post-processing alumina content in the treated soy slurry. In this regard, the soy slurry may be pre-treated in batch form to render the soy slurry into the appropriate acidic form before delivery to the column 10 for filtration therewithin.

A further step of the method of the present invention contemplates removal of the alumina particles remaining in the soy-based infant formula. It is contemplated that any number of methods for removal of alumina particles may be utilized. In this manner, the resulting soy-based infant formula produced by the above-described process therefore may be safely utilized as a nutritional product for human infants.

In a further aspect of the present invention, removal of manganese concentration levels in the infant formula may be effectuated through the use of ion exchange resins. As disclosed in U.S. Pat. No. 5,248,804 entitled Separation of Phytate from Plant Protein Using Ion Exchange, issued to Nardelli et al., and U.S. Pat. No. 5,376,393 entitled Removal of Phosphorous from Mammalian Milk Using Ion Exchange, also issued to Nardelli et al., the entire contents of both patents being incorporated by reference herein in their entireties, can be used to remove excess manganese from the infant formula.

Ion exchange resins are available as synthetic polymer beads which may be configured as small granules but which can also be membranes, fibers, tubes, and other shapes. Commonly used in the food industry and generally FDA-approved, certain ones of the ion exchange resins typically contain fixed or electric charges or ion-active groups that are each associates with a mobile counter-ion of opposite charge. The mobile ions exchange with other ions of like sign during contact with such ions in a solution. Negatively charged species of ion exchange resins contain mobile ions that are cations such that the resin is termed a cation exchange resin. Positively charged species of ion exchange resins contain mobile ions that are anions such that the resin is termed an anion exchanger.

For removal of manganese concentration from soy-based infant formula, it is contemplated that the positively charged species of the ion exchange resin may be used although some applications may necessitate the use of the negatively charged species. The use of ion exchange resins may be similar to that which is disclosed in the aforementioned U.S. Pat. No. 5,248,804 and U.S. Pat. No. 5,376,393.

It is contemplated that one type of ion exchange resin that may be selectively used for removal of undesirable metal ions, such as manganese concentrations, from various solutions, such as soy-based infant formula, is Chelex-100 which is a well known ion exchange resin commercially available from Bio-Rad Laboratories of Richmond, Calif. Chelex-100 is available in conventional bead form of the resin as well as a chromatography column of a fine particle version of the resin for use with analytical instrumentation. Chelex-100 may be used to remove or minimize certain metals such as manganese out of certain solutions such as soy-based infant formula.

Although Chelex resin is a cation exchange resin, its characteristics as a cation or an anion exchange resin can be interchanged depending upon the chemistry required. For example, although cations of zinc may be removed from a solution using a cation resin, the same resin may also be used to remove selenate anions from the same sample of solution during zinc and selenium analysis.

For the removal of manganese from an SPI slurry, the Chelex 100 resin is preferably first sieved in order to produce the narrow particle size distribution mentioned above. The column 10 preferably includes both of the bottom and top filter traps 22, 20 to prevent entrainment of the separating medium 16 in the soy slurry. The Chelex 100 resin is also preferably treated with sulphuric acid or other suitable materials in a batching process prior to filling the column 10 with the separating medium 16. Alternatively, the Chelex 100 resin may be treated in a flow process after loading the column 10. The soy slurry is preferably treated to a pH of about 4 prior to starting of any bench scale testing or production operations.

Preliminary tests are preferably performed in order to assess the conditions (e.g., flow rates) under which the alumina adheres to the separating medium 16. Initially, various particle sizes of the resin may be used at various flow rates during such preliminary tests for assessing their efficiency in removal of the Mn from an aqueous solution in order to establish a reference point. A quantitative assessment may also be initially performed to determine the extent of all minerals (including the Mn) present in the untreated and treated soy slurries.

In a further aspect of the invention, the infant formula disclosed herein may be produced by a method which further reduces manganese in such infant formula and, more specifically, in soy-based infant formula such as infant formula based on SPI. In this regard, the infant formula of the present invention may be prepared using defatted soybean flour and/or flake material as the starting material. As disclosed in “Mineral and Phytate Content and Solubility of Soy Bean Protein Isolates” by H. Honig and W. Wolf, J. Agric. Food Chem., (1987) (hereinafter “the Honig reference”), the entire contents of which is incorporated by reference herein, such starting material may be first dissolved in water such as distilled water.

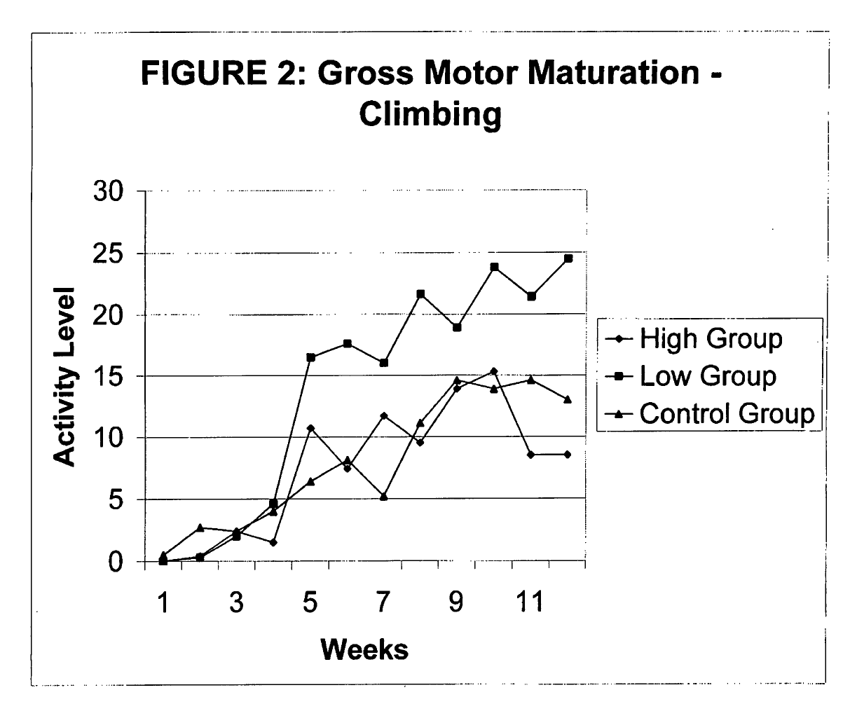

Resulting solid residue may then be discarded. The retained portion may then be processed using a combination of centrifuging and precipitation processes. As is disclosed in the Honig reference mentioned above, a second whey portion may result from such process and which is diagrammatically illustrated in FIG. 2 of the Honig reference and is denoted in the flow diagram in FIG. 2 by the character G. It is believed that this second whey portion during processing of the SPI contains a significant portion of phytate which itself contains significant levels of manganese (Mn). Therefore, by discarding the second whey portion and by further placing remaining portions in contact with a chelating agent in the manner described above, further levels of manganese may be removed from the SPI.

As was earlier indicated, such chelating agents are capable of binding certain metal irons together in a manner such that these metals are less available for nutritive purposes (i.e., less bioavailability). It is also contemplated that the entire SPI product may be exposed to the chelating agent. In the example described above, either the remaining portion (i.e., following removal of the second whey portion) or the entire SPI product may be placed into contact with the chelating agent such as alumina which acts as a separating medium for reducing manganese.

In this manner, significant amounts of manganese from soy protein and/or similar ingredients may be removed in order to provide a basis for the manufacture of low manganese or manganese-free infant formula. For example, as can be seen in Table 1 of the Honig reference, Promine R is a commercially available soy product which is shown as having a relatively low manganese concentration level. Preferably, the infant formula of the present invention may possess a similarly low level of manganese as a result of the alternative processing method described herein. As was earlier mentioned, the chelating process incorporated herein may be similar to the chelating process utilized in U.S. Pat. No. 5,248,765 issued to Mazer which describes the function of the chelating agent as a separating medium.

The alumina particles of the chelating agent may then be reconditioned upon exposure to the SPI slurry by exposing the alumina particles to sulfate solution. The spent alumina may be regenerated and reused to further produce low manganese or manganese-free infant formula. It is further contemplated that excess iron (Fe) may be eliminated during the above-described process. In order to provide a final SPI product having balanced nutritive qualities, barren iron material may be placed back into the SPI product in the desired proportion with.

In summary, this further aspect of the present invention provides a method by which excess manganese may be removed from a starting material of defatted soy bean flour or flakes. By removing the second whey fraction as mentioned in FIG. 2 of the Honig reference, significant amounts of manganese may be eliminated from the final SPI product. Even further amounts of Mn may be extracted by exposing the retained fraction to the chelating agent such that the final SPI product may have a manganese concentration level that is lower on average than manganese concentration levels in prior art infant formula.

More specifically, it is believed that the infant formula produced by the present method preferably has a manganese concentration that is no greater than about 10 times the manganese concentration found in female human breast milk. As was mentioned above, the method may further include the steps of fortifying the final SPI product with calcium, iron, vitamin D and/or Omega 3 and/or 6 fatty acids. As was mentioned above, such vitamins, minerals and acids may affect neonate's ability to absorb manganese.

Additional modifications and improvements of the present inventions may also be apparent to those of ordinary skill in the art. Thus, the particular accommodation of forms described and illustrated herein is intended to represent only certain embodiments of the present invention and is not intended to serve as limitations of alternative products or methods within the spirit and scope of the invention.

What is claimed is:

1. An infant formula for feeding to a neonate as a replacement for female human breast milk, the infant formula having a manganese concentration that is no greater than about ten times the manganese concentration in female human breast milk.

2. The infant formula of claim 1 further comprising iron for reducing a neonate's ability to absorb manganese in the infant formula.

3. The infant formula of claim 1 further comprising calcium for reducing a neonate's ability to absorb manganese in the infant formula.

4. The infant formula of claim 3 further comprising vitamin D to promote calcium absorption in the neonate.

5. The infant formula of claim 1 further comprising omega 3 fatty acid to decrease free radical distribution of excess manganese on neurotransmitters of the neonate.

6. An infant formula for feeding to a neonate as a replacement for female human breast milk, the infant formula being soy-based and having a manganese concentration that is no greater than about ten times the manganese concentration in female human breast milk.

7. The infant formula of claim 6 wherein the soy-based infant formula is comprised substantially of soy protein isolate.

8. The infant formula of claim 6 further comprising iron for reducing a neonate's ability to absorb manganese in the infant formula.

9. The infant formula of claim 6 further comprising calcium for reducing a neonate's ability to absorb manganese in the infant formula.

10. The infant formula of claim 9 further comprising vitamin D to promote calcium absorption in the neonate.

11. The infant formula of claim 6 further comprising omega 3 fatty acid to decrease free radical distribution of excess manganese on neurotransmitters of the neonate.

12. A method of reducing manganese in infant formula, comprising the steps of:
(a) providing a slurry of soy-based infant formula having a manganese concentration; and
(b) placing the slurry into contact with a chelating agent.

13. The method of claim 12 wherein the placement of the slurry into contact with the chelating agent in step (b) is for a predetermined amount of time corresponding to a predetermined decrease in the level of manganese concentration in the soy-based infant formula.

14. The method of claim 13 further comprising the step (c) of measuring the manganese concentration in the soy-based infant formula and repeating step (b) until achieving a desired level of manganese concentration in the soy-based infant formula.

15. The method of claim 12 wherein the chelating agent is comprised of particles of alumina.

16. The method of claim 15 wherein the alumina is provided in a ratio to the soy slurry of about 1.5:1 by weight.

17. The method of claim 15 further comprising the step (c) of reconditioning the alumina particles by exposure to a sulfate solution following step (b);
wherein steps (a), (b) and (c) are repeated.

18. The method of claim 12 wherein the soy-based infant formula is comprised substantially of soy protein isolate.

19. A method of reducing manganese in a defatted soy product, comprising the steps of:
(a) forming a first solution by dissolving the defatted soy product in water;
(b) forming a second solution by mixing the first solution with an alkaline solution;
(c) separating the second solution into a residue and an extract;
(d) forming a third solution by mixing the extract with an acidic solution;
(e) precipitating the protein present in the third solution;
(f) forming a fourth solution by mixing the precipitated protein of step (e) with an alkaline solution;
(g) separating the fourth solution into a precipitate and a supernatant;
(h) separating the supernatant into a gel fraction and a filtrant;
(i) forming a fifth solution by mixing the filtrant with an acidic solution;
(j) precipitating the protein present in the fifth solution;
(k) forming a sixth solution by mixing the precipitated protein of step (j) with an alkaline solution; and
(l) drying the protein.

20. The method of claim 19 wherein the defatted soy product is defatted soybean flour, defatted soybean flakes or a combination of the two.

21. The method of claim 19 wherein the water in step (a) is distilled water.

22. The method of claim 19 wherein the separation in steps (c) and (g) are achieved by centrifuging the second and fourth solutions, respectively.

23. The method of claim 19 wherein the precipitation in steps (e) and (j) are achieved by centrifuging the third and fifth solutions, respectively.

24. The method of claim 19 wherein the separation in step (h) is achieved by filtering the supernatant.

25. The method of claim 24 wherein the supernatant is filtered through cheesecloth.

26. The method of claim 19 wherein the second solution has a pH of about 7.5 to about 8.0.

27. The method of claim 19 wherein the third solution has a pH of about 3.5 to about 5.2.

28. The method of claim 19 wherein the fourth solution has a pH of about 8.0.

29. The method of claim 19 wherein the fifth solution has a pH of about 4.5.

30. The method of claim 19 wherein the sixth solution has a pH of about 8.0.

31. The method of claim 19 further comprising the steps:
(m) forming a slurry from the protein obtained in step (l); and
(n) placing the slurry into contact with a chelating agent.

32. The method of claim 31 wherein the placement of the slurry into contact with the chelating agent in step (n) is for a predetermined amount of time corresponding to a predetermined decrease in the level of manganese concentration in the soy product.

33. The method of claim 32 further comprising the step (o) of measuring the manganese concentration in the soy product and repeating step (n) until achieving a desired level of manganese concentration in the soy product.

34. The method of claim 31 wherein the chelating agent is comprised of particles of alumina.

35. The method of claim 34 wherein the alumina is provided in a ratio to the protein slurry of about 1.5:1 by weight.

36. The method of claim 34 further comprising the step (o) of reconditioning the alumina particles by exposure to a sulfate solution following step (n);
wherein steps (m), (m) and (o) are repeated.
